(19) United States
(12) Patent Application Publication
(10) Pub. No.: US 2005/0246218 A1
(43) Pub. Date: Nov. 3, 2005

(54) Method and system for tracking participant interest in trade fair vendors

(76) Inventor: Todd Benson, Rochester Hills, MI (US)

Correspondence Address: DAIMLERCHRYSLER INTELLECTUAL CAPITAL CORPORATION;CIMS 483-02-19, 800 CHRYSLER DR EAST, AUBURN HILLS, MI, 48326-2757, US

(21) Appl. No.: 10/834,509

(22) Filed: Apr. 29, 2004

(51) Int. Cl. G06F 17/60

(52) U.S. Cl. 705/10; 705/1

(57) ABSTRACT

A computer system for tracking the interest of visitors and vendors in a trade fair. The system has a plurality of sets of tokens, where each set of tokens has a unique ID which is associated with a visitor. A data entry device compatible with the sets of tokens is connected to a computer. A database is maintained by the computer and stores the associations between the unique IDs and the visitors. The database further stores a list of the vendors. For each vendor in the list, the database creates a second set of associations between the vendor and the unique IDs in response to the tokens being placed in communication with the data entry device. Each token placed in communication with the data entry is representative of the visitor associated with the token having an interest in the vendor which is being processed.

### FIELD OF THE INVENTION

This invention relates generally to computerized systems for tracking the establishment of business-to-business relationships, and more particularly to such systems wherein the relationship data for such a computerized system is derived from the presentation of tokens from one business to another.

### BACKGROUND OF THE INVENTION

Many corporations are desirous of facilitating the establishment of successful minority-owned businesses. One envisioned method of facilitating the growth of such successful businesses is for a corporation to host a forum, such as a business fair, where host corporation's suppliers may be introduced to representatives of minority-owned businesses. Since many minority-owned businesses are too small to be directly suitable for the host corporation, it is the hope of the host corporation that its suppliers' needs may instead be satisfied by the minority owned businesses. If a minority-owned business is successful in winning a suppliers' business, the minority-owned business then has the opportunity to grow organically with manageable risk and at a manageable rate.

In order for the host corporation to measure the success of its hosting effort, it is desirous for the host corporation to have a system of tracking participating minority-owned businesses and suppliers, and their resultant efforts at doing business with one another.

To date, such systems have relied on human effort and record keeping and have suffered from the shortcomings of humans. For example, persons may forget to record that an introductory meeting occurred between a minority-owned business and a supplier, they may forget to follow-up as to whether a successful business relationship grew from the host event, and so forth.

### BRIEF SUMMARY OF THE INVENTION

In accordance with these needs identified in the prior art, a computer system is provided for tracking the interest of visitors and vendors in a trade fair. The system has a plurality of sets of tokens, where each set of tokens has a unique ID which is associated with a visitor. A data entry device compatible with the sets of tokens is connected to a computer. A database is maintained by the computer and stores the associations between the unique IDs and the visitors. The database further stores a list of the vendors. For each vendor in the list, the database creates a second set of associations between the vendor and the unique IDs in response to the tokens being placed in communication with the data entry device. Each token placed in communication with the data entry is representative of the visitor associated with the token having an interest in the vendor which is being processed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE SEVERAL VIEWS OF THE DRAWING(S)

FIG. 1 depicts a computer system of the invention.

FIG. 2 depicts a trade fair arrangement of the invention.

FIG. 3 depicts a computer system of the invention.

FIG. 4 depicts a method of the invention.

### DETAILED DESCRIPTION OF THE INVENTION

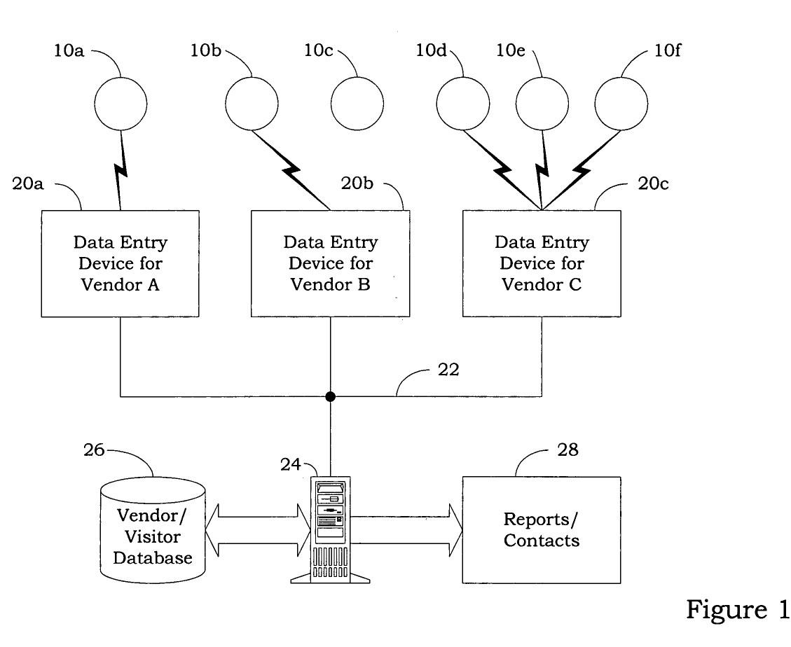

Turning now to FIG. 1, a computer system of the present invention is shown. A plurality of tokens 10a-f are provided. Each token has a unique ID and is associated with a visitor of the trade fair. A token may be, for example, an RF device, a bar coded card, a magnetic strip card, or an equivalent thereof. A token may also be substituted with a biometric of a visitor, such as a fingerprint or retinal pattern.

Each vendor of the trade fair is provided with a data entry device 20a-c for reading the tokens 10a-f. A data entry device may therefore be, for example, an RF receiver, a bar code reader, a magnetic card reader, or an equivalent thereof suitable for reading the chosen token type. In the case biometrics are used in place of a token, the data entry devices 20a-c are substituted with a biometric reader, such as a fingerprint reader or a retina-scanning device.

The data entry devices 20a-c are connected to a computer 24 via a network connection 22. The computer 24 maintains a database 26 for associating each trade fair vendor with visitors interested in developing a business relationship with a respective vendor. The database 26 makes an association between a visitor and vendor because of a vendor's data entry device 20a-c communicating with a visitor's token 10a-f. For example, in FIG. 1 a visitor associated with token 10a may be interested in developing a business relationship with the vendor associated with data entry device 20a. The interested visitor's token 10a is therefore placed in communication with the data entry device 20a in possession of the vendor. The communication between the token 10a and the data entry device 20a is represented by a lighting bolt symbol. Communication may be effected by placing an RF token in proximity to an RF receiver type of data entry device, by scanning a bar coded card with a bar code reader type of data entry device, by swiping a magnetic strip card token through a magnetic reader type of data entry device, or by whichever action is suitable for effecting communication between a chosen type of token and a chosen type of data entry device. In the event a visitor's biometric is used instead of a token, the communication may be effected by the visitor presenting his appropriate body part to the biometric data entry device.

Further inspection of the example of FIG. 1 shows that in addition the database associating token 10a with data entry device 20a, token 10b is also associated with data entry device 20b, and tokens 10d-f are associated with data entry device 20c. While not shown, it is also envisioned by the inventor that a particular token may be associated with more than one data entry device 20a-c.

The computer 24 generates reports and contacts 28 representative of the visitor token/vendor data entry device associations made in the database 26. The reports may show, for example, each association made, the quantity and identities of visitors, and the quantity and identities of vendors. The computer also generates letters for delivery, either by electronic mail via the internet or by the postal service, where the letters provide a formal introduction between the vendors and visitors associated in the database 26.

In one embodiment, the visitors of the trade fair are representatives of suppliers and the vendors are representatives of minority-owned businesses, however it is envisioned that the positions of the visitors and vendors may be swapped. The facility and computer system may be provided a host corporation.

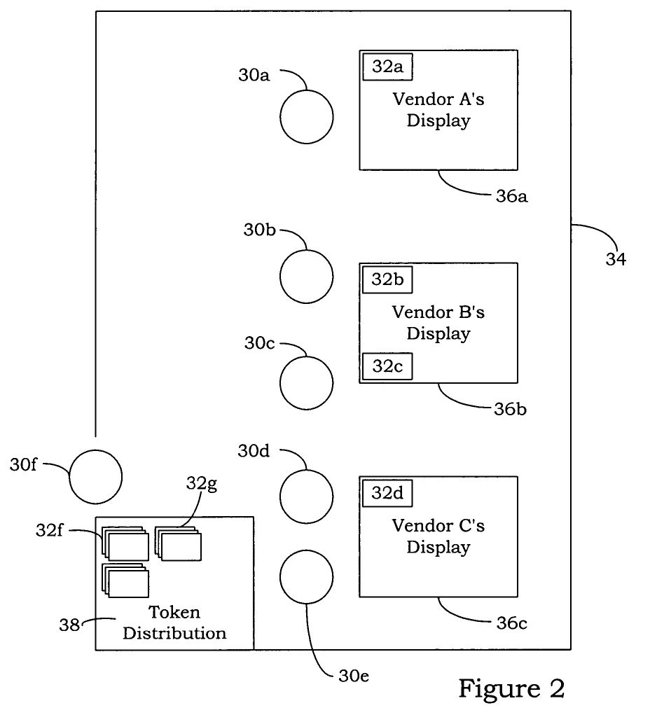

Turning now to FIG. 2, an alternate embodiment is shown. A trade fair space 34 is provided. Each visitor 30 is associated with a set of unique tokens 32a-g. In this embodiment, a token may be, for example, an RF device, a bar coded card, a magnetic strip card, or an equivalent thereof. In the example of FIG. 2, visitor 30a is associated with unique tokens 32a, visitor 30b is associated with unique tokens 32b, and so forth. Sets of unique tokens 32f-g wait to be associated with arriving visitors, such as arriving visitor 30f. The association between a set of unique tokens and arriving visitors preferably occurs at a token distribution area 38, however it is envisioned that such association may also take place prior to the trade fair, such as during a registration period for prospective visitors.

Once in the trade fair space 34, visitors 30a-e are free to visit any or all of the vendors 36a-c. If a particular visitor is interested in exploring a business relationship with a vendor, the visitor then leaves one of his tokens with the vendor. In the example of FIG. 2, it can be seen that visitor 30a has left one of his tokens 32a with vendor 36a. This indicates that visitor 30a is interested in exploring a business relationship with vendor 36a. Similarly, it can be seen that visitors 30b-c are interested in exploring business relationships with vendor 36b, and visitor 30d is interested in exploring a business relationship with vendor 36c. Visitor 30e has not left one of his unique tokens (which would be 32e) with a vendor and has therefore not yet indicated an interest in exploring a business relationship with one of vendors 36a-c.

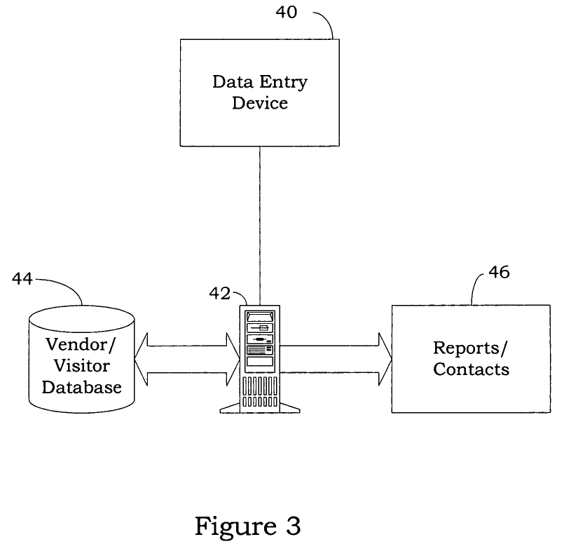

At the conclusion of the trade fair, the tokens are collected from each vendor. Each vendor's tokens are kept in a group separate from the tokens collected from the other vendors. Each token within a group of tokens is then placed in communication with a data entry device 40 such that shown in FIG. 3. Communication may be effected by placing an RF token in proximity to an RF receiver type of data entry device 40, by scanning a bar coded card with a bar code reader type of data entry device 40, by swiping a magnetic strip card token through a magnetic reader type of data entry device 40, or by whichever action is suitable for effecting communication between a chosen type of token and a chosen type of data entry device 40. This process is repeated for each group of tokens.

The data entry device 40 is connected to a computer 42. In response to the communications between each token and the data entry device 40, the computer 42 maintains a database 44 that associates each vendor 32a-c with its associated group of tokens that were collected at the conclusion of the trade fair. The database also maintains an association between each unique token 32a-f and the particular visitor 30a-f to which it was assigned when the tokens were initially distributed to the visitors. The computer 42 then uses information in database 44 to generate reports that may show, for example, each association made, the quantity and identities of visitors, and the quantity and identities of vendors.

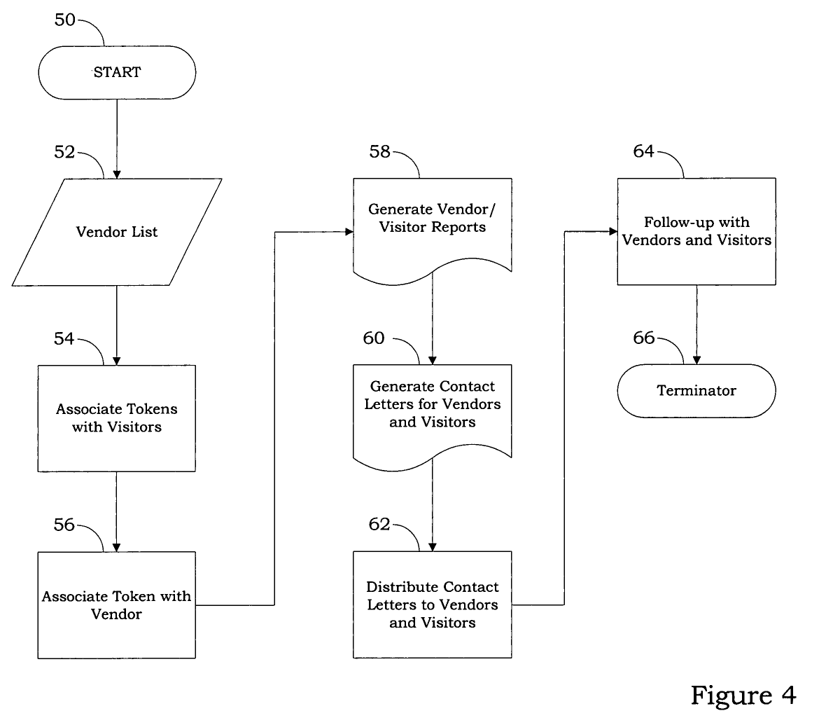

Turning now to FIG. 4, a method of the present invention is described. The method is preferably executed by computer 24 or 42, depending on the chosen system architectures from FIGS. 1 and 2. The method is entered at block 50 and progresses to block 52. In block 52, a vendor list is created. In the event each vendor is in possession of a data entry device 20a-c, the vendor list associates each vendor with his data entry device 20a-c. From block 52 the method progress to block 54 and associates a token with each visitor. In the event tokens are substituted by biometrics, each visitor is associated with his respective biometric. From block 54, the method progresses to block 56. In block 56, a particular token is associated with a particular vendor each time a token is placed in communication with a data entry device. From block 56, the method proceeds to block 58 where the reports are generated based on the associations made in block 56. From block 58, the method proceeds to block 60 and contact letters are generated for the trade fair visitors and vendors. Again, these letters are generated based on the associations made in block 56. The letters serve to facilitate the creation of a business relationship between the visitors and vendors in response to the presentation of tokens made during a trade fair such as shown in FIG. 1 or FIG. 3. The letters are distributed to the respective vendors and visitors in block 62. In block 64, the hosting corporation may follow-up with the trade fair participants, e.g. the visitors and vendors, in order to determine whether successful business relationships occurred because of the trade fair. This allows the hosting corporation to determine a degree of success of the trade fair.

While the best mode for carrying out the invention has been described in detail, those familiar with the art to which this invention relates will recognize alternative designs and embodiment for practicing the invention. Thus, the above described preferred embodiment is intended to be illustrative of the invention that may be modified within the scope of the following appended claims.

1. A computer system for tracking the interest of visitors and vendors in a trade fair, the system comprising:
a unique token in a first association with a visitor;
a unique data entry device in a second association with a vendor;
a computer connected to said data entry device; and
a database maintained by said computer, said database maintaining said first association and said second association; and
in response to a communication between said unique token and said data entry device, said database maintains a third association between said unique token and said unique data entry device, wherein said computer generates a report showing said third association, thereby facilitating the tracking of interest between the visitors and vendors.

2. The computer system of claim 1 wherein said unique token is a bar coded card and said unique data entry device is a bar code reader.

3. The computer system of claim 1 wherein said unique token is an RF device and said unique data entry device is an RF receiver.

4. The computer system of claim 1 wherein said unique token is a biometric and said unique data entry device is a biometric reader.

5. A computer system for tracking the interest of visitors and vendors in a trade fair, the system comprising:
a plurality of sets of tokens, each set of tokens having a unique ID in association with a visitor;
a data entry device compatible with said sets of tokens, said data entry device being connected to a computer;
a database maintained by said computer, said database storing said associations between said unique IDs and said visitors, said database further storing a list of the vendors; and
for each vendor in said list, said database creating a second set of associations between said vendor and said unique IDs in response to said tokens being placed in communication with said data entry device, wherein each token placed in communication with said data entry is representative of the visitor associated with the token having an interest in the vendor in said list which is being processed.

6. The computer system of claim 5 wherein said sets of bar-coded cards and said data entry device comprises a bar code reader.

7. The computer system of claim 5 wherein said sets of tokens comprise RF devices and said data entry device comprises an RF receiver.
